(19) United States
(12) Patent Application Publication
(10) Pub. No.: US 2006/0161856 A1
(43) Pub. Date: Jul. 20, 2006

(54) Data collection tool for a computer

(75) Inventor: Harvey J. Heir, New Rochelle, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 11/039,496

(22) Filed: Jan. 20, 2005

(51) Int. Cl. G06F 9/00

(52) U.S. Cl. 715/769

(57) ABSTRACT

A system and method for enabling the capture of visible and hidden information about files and data on a computer and rendering collected data accessible as a data file. The system and method provides an interface adapted to invoke computing platform API's to expose and capture useful information about computer resources without the need for specialized software. The interface is manifested as a graphic element or icon that can be dragged to a target object or area on the user's display screen where it collects information contained in or about a target object or area. The specification of the target and the information that should be collected from the target are configured for each instance of the icon. The system and method provides the ability for the icon to selectively connect with an object and perform a capture data from the target object without interacting with or influencing the target or the objects in the target.

### FIELD OF THE INVENTION

The present invention relates to computer user-interfaces and particularly, a new O/S tool that gathers and normalizes information about data from a variety of dissimilar sources. The tool can be used to collect and organize data from documents, programs, web sites, and other standard resources and return data for different user needs.

### BACKGROUND OF THE INVENTION

Computer users for many reasons have many occasions to collect data, content and information from many dissimilar sources, including, but not limited to: Documents, e-mail, Programs, Web pages, Search engines, System generated windows or messages on the desktop (e.g.: error messages), etc. For purposes of discussion, it is assumed that a majority of the computer users implement a Windows®-based computer or like-computing device providing a windows interface wherein during the course of use, whether it is for personal, business, or educational or scholastic research purposes, a user may need to collect and organize data, content and information from many dissimilar sources. The information that is gathered may be text, data, and links to other resources or other more complex objects. Over a period of time the user will want to recall one or more sets of these data and perhaps use them for other purposes.

Currently, there exists no known solution implemented in computing devices for enabling the gathering, collection and saving of similar or dissimilar data, content and information from a variety of sources.

It would thus be highly desirable to provide a system and method that would enable a user of a computing device to gather, collect and save similar or dissimilar data, content and information from a variety of sources.

### SUMMARY OF THE INVENTION

It is an object of the present invention to provide a system and method that would enable a user of a computing device to gather, collect and save similar or dissimilar data, content and information from a variety of sources.

It is a further object of the present invention to provide a system and method that would enable a user of a Windows-based or similar Windows-type computing device to gather, collect and save similar or dissimilar data, content and information from a variety of sources.

It is a further object of the present invention to provide an interface that enables a computer user to capture visible and hidden information about files and data on their computer and makes them accessible as a data file. It represents a process that a user can invoke to expose and capture this useful information about resources on their computer without the need for specialized software.

In furtherance of these stated objectives of the present invention, it is an objective to provide a system and method that would provide a simple and convenient way to enable a user to gather, collect and save similar or dissimilar data, content and information from a variety of sources and to have the saved similar or dissimilar data, content and information recalled in a convenient, configurable way.

Preferably, there is provided a user interface for collecting information which is initiated by selecting an “object collector user interface” (OCUI) or alternately referred to as a “Collector Icon” that will enable users to collect any data that can be defined via standard Windows interfaces, including, but not limited to: OLE (Object Linking and Embedding); COM (Component Object Models); Hyper links; Clipboard objects; Highlighted data; Object data; Object attributes, etc. The data that the user selects will be collected in a normalized way (that is, it will be saved in some consistent and homogeneous form) that the user can recall and use. For instance, if the user is searching the web and collecting relevant hyper links from a list of URL's in a search result page, the “Collector Icon” object would collect the URL and associated information defined by the user, such as current date and time, source, URL, link text, etc. Subsequently, the user may call up the list of collected hyper links, review any associated information and use that list to navigate to other resources.

Preferably, the format for saving, recalling, and using the collected information is configurable. For instance, the collected list may be saved as an HTML file, an XML resource, a text document or some other convenient format.

Advantageously, the OCUI solution of the invention allows the user to collect data that normally would require programming interfaces to perform the job. The OCUI icon additionally allows the user to collect data, such as error messages or information from transient windows, which, for example, would otherwise be captured only in screen-shots. The type of data that can be collected and how it gets stored are defined by standard O/S (such as Windows®) defined resources and data interchange technology. All of this data can be collected as research or history and used for other purposes. It is understood that the invention is implementable not only in a Windows®-based or similar Windows®-type interface, but may be implemented in LINUX, AIX, and Mac platforms, and, generally, any platform having a GEUI (General End User Interface) that allows function to be performed through the manipulation of icons.

Advantageously, the OCUI interface of the present invention does not interfere with the data it is collecting. Target objects may be observed and attributes recorded without having any affect on the target process or object.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts conceptually a detailed view of an Object that the OCUI icon of the present invention can work with, and a computing system structure in which it is employed;

FIG. 2 depicts action of the OCUI Icon being dragged and dropped onto a target element 20 in a windows area displayed on a display interface;

FIGS. 3(a)-3(i) illustratively depict the process steps for generating and using the OCUI icon 11 according to a first example application of the present invention;

FIGS. 4(a)-4(e) illustratively depict the process steps for generating and using the OCUI icon according to a second example application of the present invention;

FIG. 5 illustratively depicts the web browser interface having a URL line in which the user may enter the URL of the search web site according to the second example application utilizing the OCUI icon of the present invention;

FIG. 6 illustratively depicts the results of the search executed in FIG. 5 that are returned to the user in a new interface window;

FIG. 7 illustratively depicts the utilization of the OCUI icon according to the second example application whereby a user drags the OCUI Icon to the window and releases it;

FIG. 8 illustratively depicts the subsequent examination of the word processor documents and the associated text of the document according to the second example application;

FIG. 9 illustratively depicts the subsequent utilization of the OCUI icon according to the second example application whereby the user may drag the OCUI Icon to the window and releases it to enable the “capture” action; and,

FIG. 10 illustratively depicts the collector properties dialog box 140 for the OCUI icon according to the second example application indicating the results statistics pertaining to the text items occupying space in the specified save area.

### DETAILED DESCRIPTION OF THE PREFERRED EMBODIMENTS

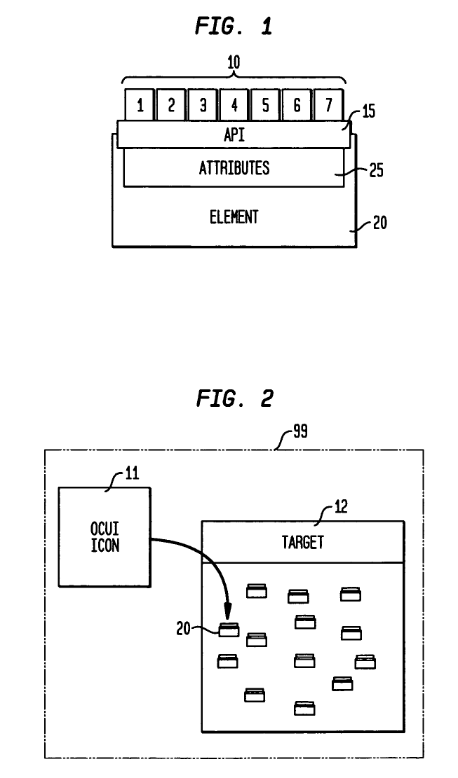

Referring to FIG. 2, there is generally shown a general end user interface (GEUI) 99 provided with a computing device that includes an object collector user interface “OCUI” which is an end user interface manifested as a graphic element, i.e., an OCUI “icon” 11, on the computer user's screen, for collecting data according to the invention. The general end user interface 99 may comprise a display monitor for any computing device, including a PC, laptop, or, any mobile or personal computing device. A prerequisite for implementing the OCUI interface is that the computing device platform in which it operates provides a programming interface that exposes the attributes of objects represented and used by the GEUI as will be described in greater detail with respect to FIG. 1.

Particularly, the invention includes the novel OCUI end user interface manifested as an icon 11 that appears as a conventional icon on the computing device display as shown in FIG. 2. The Icon 11 can be dragged to a target object or area 12 on the user's screen where it is released and collects information from the objects contained in or about the target object or area. Preferably, the specification of the target and the information that should be collected from the target are configured for each instance of the OCUI Icon 11.

As will be explained in connection with illustrative example embodiments of the invention, in operation, the OCUI icon 11 must first be configured. Then it is dragged by the user to a target area, and, upon releasing the icon, a menu is presented to the user with a list of options that enables the user to select an action to be performed. One important aspect of the invention is the ability for the icon to perform a data capture from the target object without interacting with or influencing either the target area or the objects in the target. That is, the OCUI icon may selectively connect with an object, observe and record information without having any affect on the target process or object. The richness of the platform and the extent of the programming of the interface define the level of versatility of the interface.

Thus, referring to FIG. 2, the end user interface of the invention includes the following: 1) an Icon 11 that may be dragged to a valid target area 12 and released; 2) an action menu which is displayed over a valid target area when the Icon is released; 3) the “Collect” action provided with the action menu that invokes the interface which will acquire information from appropriate objects in the target based on the ICON's user specified configuration information; and, 4) a structured save area where the information collected from Objects in the Target area is appended. The unique functions that this interface performs are: 1) Collecting data, Attribute data and related data from and about Objects in a specified target area without interacting with or influencing the target area or the objects contained in the target area; 2) Accumulating the collected data by appending it to a save area that can be reviewed by the user and exported to a process that formats the accumulated data.

Enhancements to the end user interface that assist the user to configure the properties of the interface and manage the collected data include the following: 1) the ability to preview and configure the desired type of a Target area; 2) the ability to preview and configure the desired type of an Object; 3) the ability to preview and configure desired Attributes of various Objects; and 4) the ability to provide a customization dialog that allows the user to review, selectively delete and format the collected data when it is exported.

In a preferred aspect of the invention, Objects in a Target do not have to be homogeneous. That is, a collection of Objects can have Attributes that are identical, such as “Name”, and Attributes that are dissimilar, such as “Album” or “Vertical Position”. The OCUI can capture any of these Attributes as long as the Attributes may be exposed by programming interfaces in the operating system or application platform. If, when collecting Attributes from an Object, the Object does not have some of the requested Attributes then the value for the missing Attributes will be recorded as empty. Information that is collected from each Object in a Target area is stored in a structured save area which associates the desired Attributes with the identification of the Object from which they were collected. The collected Attributes of the captured Objects can be recalled by the user. Further, the save area is unique for each instance of an OCUI Icon and can not be shared among other instances of the OCUI Icon.

The manner in which the OCUI icon is configured is now described in greater detail. Each instance of an OCUI icon must be configured, i.e., it has properties that must be specified by the user before it can be utilized. It must be possible for a user to import and export the properties of an OCUI Icon. This will allow the distribution of special purpose configurations to users. Importing an Icon configuration does not assure that all of the settings are correct. The user must review the settings and make any platform related or customized changes that are necessary. The properties of the OCUI Icon are defined as: 1) the Target; 2) Selected Objects; and 3) Selected Attributes. An additional property of the OCUI Icon concerns the 4) save area where accumulated results are stored when the Icon is used to collect data. Thus, the type of target that the OCUI icon recognizes must be defined. The Icon, when it is dragged to the target and then released, will automatically recognize the boundaries of the target and collect information from unique objects within those boundaries.

Target Property

A Target is the description of a container where the Objects to be selected by the icon can be found. There are various types of containers defined by operating system platforms and thus, the target property may be any defined space or object that is supported by the operating system or application platform. Only one Target type can be specified for an instance of an OCUI Icon. When the OCUI Icon is dragged to a valid Target and then released, the interface will recognize the boundaries of the Target and collect information from Objects contained within the Target's boundaries. Example targets include, but are not limited to: 1) an inscribed area on the screen that has been marked by the user. The inscribed area may comprise an arbitrary portion of the screen that has been defined by the user, e.g., defined by drawing a box around a portion of the screen. The inscribed area does not have to be limited to any logical boundaries on the screen, such as program windows or system areas and it could be a subset of a window or it could run across windows. The area must contain Objects; 2) a window which is any presentation space (e.g., a main window or a defined area within a window) that is defined by the operating system or platform. The boundaries of a window are defined by the platform's interfaces; 3) another icon or collection of icons which are the pictorial representation of system objects and can represent many things such as files, programs, or programmed interfaces. The user can select one, many, or any set of Icons as a target. Selecting multiple Icons is a platform-defined process. One could select a set of icons from within a window that lists files or other objects; and 4) a text or graphic area. Using conventional selection techniques, the user can select data or objects within a program presentation space or window. The Icon can be configured to limit its operation to just the selected Objects in the Target area. The OCUI Icon would then work with the selected data. Thus, for example, if the OCUI Icon is dragged to a target, such as a window, and the Icon is configured to collect information from files, then all of the files selected in the window will be examined and their information captured. The files that were not selected will be ignored. If the OCUI Icon is dragged to a marked text area in a Web Browser and the Icon is configured to capture text and hyperlinks, all of the marked text and hyperlinks in that target will be captured.

Object Property

Objects are discrete entities that are contained in a Target. When an OCUI Icon is dragged to a place where there is a valid Target and then released, the Target will be recognized and all of the Objects in the Target will be available to the OCUI. Object types may represent links or shortcuts to the object that would direct a user to the object. This is an indirect reference to the object and can be treated as the object itself. The OCUI configuration identifies the type of Object that the user wants to select. Only one type of Object may be selected for any instance of an OCUI. The variety of Object types available to the interface is defined by the platform on which the OCUI is implemented. The user may qualify the selection of an Object by adding restrictions or conditions for selecting instances of the Object. For example, if the Object is a “File” the profile could specify a “file mask” that limits the selection to files whose name match the “file mask”. Objects have Attributes that can be collected. When an Object is identified as selectable, all of its Attributes become collectable. If the profile identifies an Object as selectable and the object exists within the Target then the OCUI can explore and capture any of its Attributes. The set of selected Objects within a Target can include all of the Objects in the Target or only the Objects that the user has highlighted within the Target. If the user wants to work with only a subset of Objects in a Target, that subset of Objects must be highlighted before the OCUI Icon is dragged to and released over the Target area. Highlighting is a quality that marks an object as “selected” and is defined by the platform on which the OCUI is implemented.

Attribute Property

The Attributes are the properties of an Object and data content of an Object that can be examined using programming interfaces of an Object. They are defined by the operating system platform, various programming interfaces, and user settings within in the operating system. Each Object has a set of Attributes that are visually exposed to the end user. There are other Attributes that are only exposed as programming interfaces and are not visible to the user. The OCUI must be configured to identify which among all of these exposed and unexposed Attributes the user wants to capture when the Object is selected from within a Target area. Multiple Attributes can be collected from any Object. In addition to the Attributes of Objects, there are referential Attributes that are related to the capture process that collects information from the Object. These too can be collected. Although the OCUI does not presume the meaning or use of the Attributes it collects from an Object they are considered in an organized way. Referential attributes generally describe how the Object is accessed, used, or known to end users, programs and the operating system platform. Attributes may include, but are not limited to the following types: 1) General—General attributes refer to the object itself, such as the object's name or title, creation date, last used date, size, shape, physical or logical characteristics; 2) Referential—Referential Attributes refer to the how the OCUI acquired information from the Object and may include the date and time that the Object was “collected”, the identification of the Target area (container) where the Object was found, the name of the OCUI Icon that collected the data, the name of the user that collected the data, and any other data related to collecting the Object's attributes; 3) Unique—In a Target area some Objects may have Attributes that are not found among other Objects. For instance, the size of a text Object could be measured in words, but there is no analogous value for a sound or graphic Object. Music objects have Attributes such as playing time and album title. Graphic images have color pallets. If the OCUI Icon is configured to capture a unique Attribute and some selected Objects in the Target area do not have that Attribute, an empty result will be collected for that Object's missing or otherwise inconsistent Attribute; and 4) Content—Content refers to the value that the Object displays or represents. For a text Object, it would be the text that has been selected. A graphic image would have a binary value representing the image. Some Objects may include links or hyperlinks to other information. The link information would also be part of the Attribute's content.

The OCUI can be configured to select any set of valid Attributes of Objects in the Target area. If an Object is selected within a Target area and it has any of the selected Attributes, those Attributes will be collected. If referential Attributes are specified in the OCUI Icon's configuration then all of the other specified information related to the Object and Target will also be collected. When there are multiple Objects in the Target, the user can choose which objects will be selected and which objects will be ignored. The user can highlight the objects to be selected before dragging and releasing the OCUI Icon over the Target area. In that case, only the highlighted Objects in the target will be used by the OCUI and only their Attributes will be collected. Highlighting an object as selected is a platform dependent process.

Collection Results Property

Any implementation of the OCUI must include a way to render the collected results for the user. The OCUI thus, must be associated with a structured storage area where the interface will accumulate the information it collects as the Icon is used. Information is accumulated by appending it to a storage “results” area which may comprise a flat file or like storage area in a memory storage device, e.g., RAM, cache memory, hard disk media, e.g., disk drive, magnetic or optical disk media, removable disk media, a database location, etc. The user must name this storage area. The storage area is used as input to the process that exports the collected data for the user. The implementation of the OCUI must include an option to export the storage area in some convenient format. Thus, the invention includes an interface provided to allow third party programs to access data in the storage area so that it can be custom formatted for the user. For example, the default export format could be a comma separated value (CSV) text file, but a custom-program could format the data as an HTML file. The collected results are thus configured by the user and may comprise: the Attributes of the Object; the Demographics of the Object; and, the manner in which each Object was collected. The results are stored in a structured way so that each Object and its associated Attributes can be individually identified. All information in the Results area is organized by Object. The Results area is uniquely associated with a single instance of an OCUI Icon. The interface additionally provides a way for the user to manage the stored results. The user must be able to review the status and content of the collected results and be able to selectively delete any or all Object data from the stored results. The user must also be able to export the data. Exporting the data is implementation dependent with the implementation including a convenient method to export the data so that it is accessible to the user as a file. The implementation also provides program interfaces that allow the user or third party programs to access the collected results so that they can be custom formatted in any desired way.

FIG. 1 depicts conceptually the computing system structure in which the OCUI is employed. The description and definition of each of the control blocks and interfaces on which the OCUI is implemented depends on the implementation platform. Example platforms include, but are not limited to: the Windows operating system in its various versions; the UNIX operating system with its various implementations, such as AIX and LINUX. Within an interactive platform there is a desktop with windows and objects. The OCUI is primarily interested in Icons, the objects that the Icons represent, and the contents of Windows. It is presumed that the computing platform supports the following: 1) Drag and Drop functionality: an icon can be dragged to a target location and released at that location. When the icon is released an action will be initiated based on the method used to drag the icon and the target location where it is released. The target location may be a window or another icon, or both. The action that is initiated is based on internal and external properties of the icon and the target location. Implementing the OCUI requires access to these properties; 2) Object Linking and Embedding (OLE) capability which is a Microsoft technology which allows one to link elements from different applications within each other. An element is something that defines an object or a target. The technology defines Application Programming Interfaces (APIs) that allow programs to identify elements from one environment and integrate them into another environment. Implementing the OCUI is dependent on these APIs; and 3) Marking and Selecting functionality which comprises methods for defining a boundary and selecting objects or elements within that boundary. Either the process of selection or the process of defining the boundary may come first. A boundary is typically defined by drawing the boundary with a pointing device, such as a mouse. The boundary can be implicitly defined as the current active window, some other target window, the user's desktop, or some other explicit area of the screen. The platform may also provide for a user-defined boundary that can span windows and objects. Selecting objects or elements is defined by the platform. There should be an API that identifies the objects or elements within the boundary and which among them have been marked as selected.

Thus, the OCUI 11 of the invention is based on object and target elements. The target 12 will contain objects or, as will be referred to herein “elements” 20. The OCUI 11 is able to collect information from elements 20 in the target based on (application programming interfaces (APIs) 10 and 15, for example, offered in the implementation platform. An object element 20 will have internal attributes 25 which are exposed via an API. In FIG. 1, there are illustrated seven APIs 10 and 15 identified for this target element 20. Each API would provide a different set of information about the element and can also be used to influence the element by changing its shape or content. It is understood that, in practice there could be hundreds of such APIs such as those API's that are published by Microsoft and other operating system vendors, e.g., they are exposed as functions in C, C++, and other languages. It is also understood that the OCUI implementation does not exercise any API that would modify the element.

Thus, in the example depicted in FIG. 1, the APIs 10 and 15 may represent the following: 1) The name of the element which defines how the element is known to the system; 2) The program that is associated with the element which indicates which, if any, program will utilize or render this element; 3) The logical size or dimensions of the element. Thus, where appropriate, the size of the element could be represented in bytes, rows and columns, pixels, or other units of measure; 4) Pointers to the content of the element. That is, based on the logical size of the element, the content can be identified as bytes of text, a graphic vector, referential information, or any other information that is organized and quantified within-the element; 5) The state or status of the element: this would indicate if the element is “selected”, accessible, restricted, protected, or other parameters that describe the permission needed or use of the element; 6) Current use, such as how the element is being shared, e.g., the element could be shared by other processes. If so, those processes could be identified. Use of the element may be restricted by these shared users; and, 7) Networking information for the element: This describes how to access the element or, what resources are needed to work with the element.

Not every API is needed to support the OCUI. However, each API will contribute an attribute that could be collected by the OCUI. The implementation of the OCUI will be based on the many available attributes and APIs associated with elements in the platform.

The OCUI Icon Program Structure

As shown in FIG. 2, the OCUI Icon 11 represents a program that is dragged and dropped onto the target element 20 in the target area 12 displayed on a display interface. The element 20 is typically an object or some data in the area that is typically a window 99 on the user's desktop. The target element 20 will represent an object or objects that have APIs and attributes. The action of dragging the OCUI Icon 11 to the target and releasing it gives the OCUI program access to the target's Objects and attributes included in the target. Thus, the program can enumerate the Objects, and based on how the user has configured the OCUI Icon, the program can collect information by going through the list of target Objects and evaluating them for processing. As shown in Table 1, this action gives the OCUI Icon program access to each of the Objects 20 in the target 99 and all of each Object's attributes. Each Object will have its own attributes that the program can work with. Note: in Table 1 that Attribute 2 is not appropriate for Object 2.

TABLE 1

| Elements | Attribute 1 | Attribute 2 | . . . | Attribute n |
|---|---|---|---|---|
| Target: | = = = = | = = = = | . . . | = = = = |
| Object 1: | = = = = | = = = = | . . . | = = = = |
| Object 2: | = = = = | n/a | . . . | = = = = |
| . . . | = = = = | = = = = | . . . | = = = = |
| Object n: | = = = = | = = = = | . . . | n/a |

In one example application, the OCUI is configured to build a list of information from music files (e.g., *.MP3 format). In this example, a user wishes to create a list of music files that are stored in various directories on a Windows® system. The information the user wants to collect is: 1) the name of the file; 2) the music title and artist of the music; and 3) the playing time of the file. When the list is completed the user wants to format the collected data in the example embodiment as a Comma Separated Values (CSV) file. It is understood that the user could easily specify a customized format for the collected data such as an HTML Web Page with hyperlinks to the original music file, for example. The tasks that the user has to perform include: 1) Create and configure a new instance of an OCUI Icon; 2) Open windows that have lists of music files; 3) Drag the Icon to the lists of music files and collect the configured information; 4) Review the ongoing results; and, 5) Export the collect results as a CSV file.

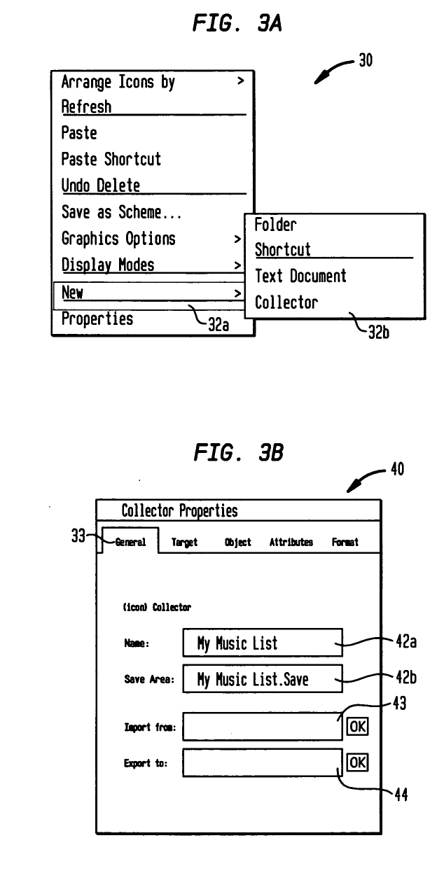

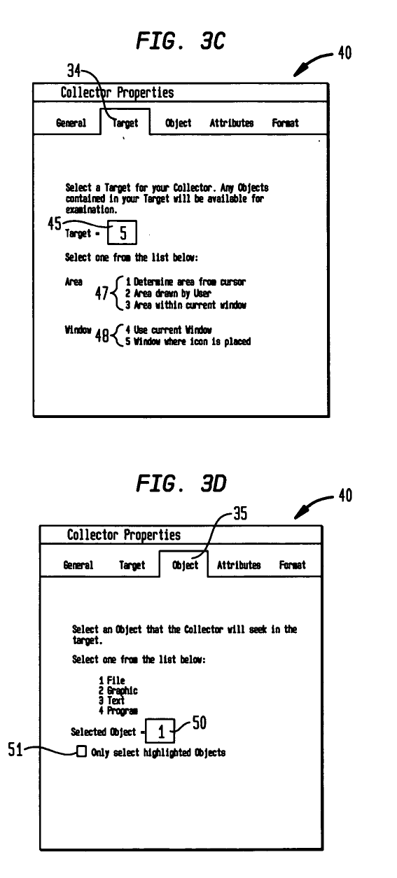

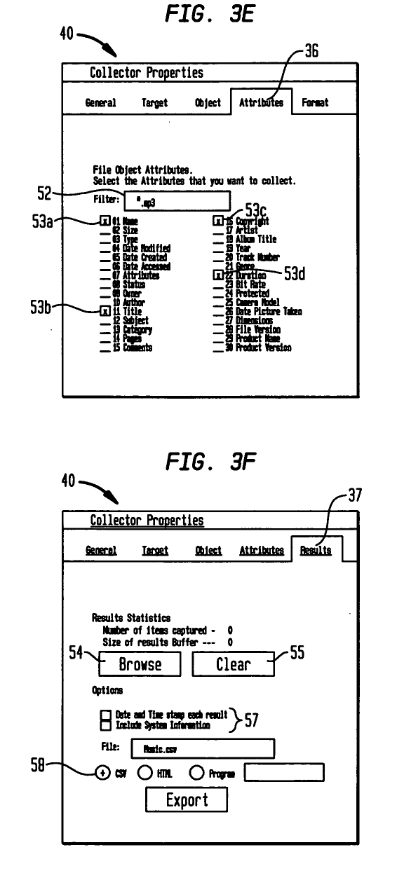

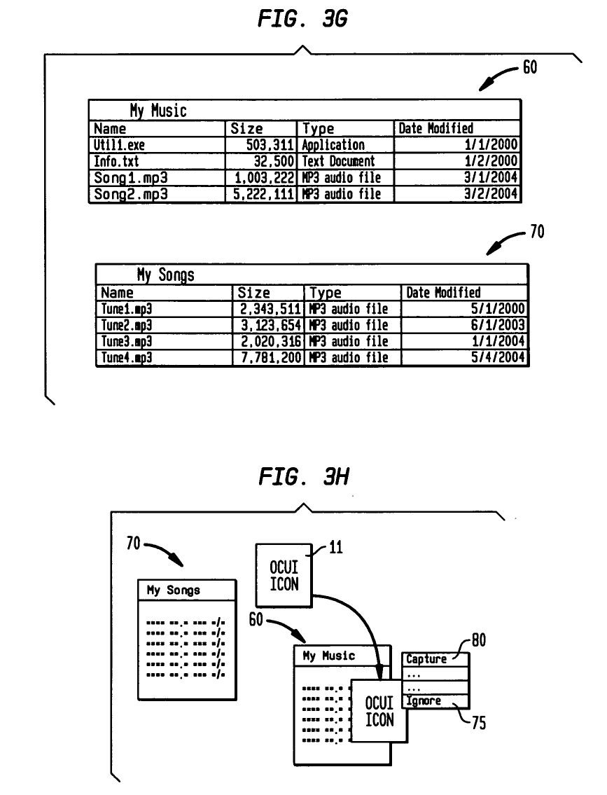

FIGS. 3(a)-3(h) depict the manner in which a user creates the OCUI Icon according to this example application. As shown in FIG. 3(a), the user may first simply “right click” on the desktop area which, in response, generates a drop down menu 30 having menu options. From this menu, the user may select the “New” and select “Collector” options 32a, 32b to generate a new OCUI icon 11 in the manner as shown. Referring to FIG. 3(b) in connection with this example application, a “Collector Properties” dialog box 40 is displayed in response to creating a new OCUI icon from which the user may configure the properties of the OCUI Icon. Particularly, as shown in FIG. 3(b), the user may select the general tab 33 providing entry fields enabling entry of the following general properties of the new OCUI icon including: 1) the Name of the Icon in display entry area 42a (e.g., “My Music List”); and, 2) the name of the save area in display entry area 42b (e.g., “My Music List.Save”). Additional entry fields 43, 44 via the collector properties interface 40 enable the user to further specify locations where attribute data may be imported from or exported to, respectively.

FIG. 3(c) depicts the manner in which a user configures the Target property of the example OCUI Icon generated according to this example application. In response to the user clicking on the “Target” tab 34 from the collector properties interface 40, the user is presented with a dialog box enabling user selection and entry of a target for the created Collector icon. In the example depicted in FIG. 3(c), the user has input a target value equal to “5” in entry field 45 because the list of music files for the intended application will be found in a Window. Thus, when the Collector Icon is dragged to a window, it will use the boundaries of the window as the Target area to search for Objects. Thus, any Objects included in the Target will be available for examination. Further, Target values 47 enterable by a user may include values representing potential target areas 47 such as: 1) an area determined from a cursor; 2) an area drawn by User; and 3) an area within a current window. Further target values enterable by a user may include values representing a target window 48 such as: 4) the current window or, 5) the Window where Icon is placed.

FIG. 3(d) depicts the manner in which a user configures the Object property of the example OCUI Icon generated according to this example application. In response to the user clicking on the “Object” tab 35 from the collector properties interface 40 of FIG. 3(a), the user is presented with a dialog box enabling user selection of an object for the created Collector icon. The user must identify the Object that the OCUI will examine. In the example application, the user has input an Object value equal to “1” in entry field 50 because that user is looking for files that are music files. This does not assure that the target will contain any music files. Note that in the example application depicted, the user did not check the box 51 to select only highlighted objects. Thus, this selection choice will enable collection of all files in the Target window. It is understood that only one Object type can be selected. If the user had checked the “Only select highlighted Objects” box 51, then only the highlighted files in the window would be used by the OCUI, for the example application.

FIG. 3(e) depicts the manner in which a user configures the Attribute property of the example OCUI Icon generated according to this example application. In response to the user clicking on the “Attributes” tab 36 from the collector properties interface 40 of FIG. 3(a), the user is presented with a dialog box enabling user selection of attributes for the created Collector icon. In the example shown in FIG. 3(e), the Attributes tab has automatically recognized that, for this example, the Object tab 35 is set to “File”. The selection of Attributes is thus dynamically formatted to include only Attributes of file Objects. However, the Attributes dialog interface 36 shown in FIG. 3(e) enables user selection of any or all attributes for the specified object type. Via the Attributes dialog interface, the user is further enabled to customize a file name mask via filter entry field 52. In the example shown in FIG. 3(e), the user customizes a file name mask by entering “*.mp3” which will limit the selection of Objects to files with the .MP3 file extension. As shown for the example Object depicted in FIG. 3(e), the user has selected attributes to be collected when the icon is invoked including: a Name 53a, Title 53b, Artist 53c, and Duration 53d, i.e., attributes associated with music files. In the example application depicted in FIG. 3(e), it is understood that a “pages” attribute is listed; however, as it is not an appropriate music file attribute, if it were to be selected, it would return an empty value when collecting data from a music file. It is also understood that by entering a file mask of “*.mp3” the files that match that mask do not have to be music files.

FIG. 3(f) depicts the manner in which a user configures the Results property of the example OCUI Icon generated according to this example application. In response to the user clicking on the “Results” tab 37 from the collector properties interface 40 of FIG. 3(a), the user is presented with a dialog box enabling user selection of Results for the created Collector icon. The Results dialog box particularly shows the current status of the save area and how the results will be managed. Since this is a new Icon there is nothing in the save area as depicted in FIG. 3(f). That is, the number of items captured and the size of the results (buffer) indicate a null in this example. Subsequently, the user can Browse or Clear the current set of results using the respective Browse button 54 or Clear button 55 provided. The Results dialog box further enables a user to “check” the Options 57 menu choice in order to collect additional information when new results are added to the save area. For example, the user is enabled to indicate that the Collector icon collect Date and Time stamp information in a first options menu choice for each result, and further provide an option to include System Information for each result.

As shown in FIG. 3(f), the user has left blank the options to collect additional information when new results are added to the save area. As further shown, the CSV output format has been selected by the user in the example application, in response to the user designation of the output file to be named “Music.csv” and the selection of the CSV radio button file Export choice 58. Alternatively, the user may select an “HTML” radio button file export choice or, a programmable format via selection of the “Program” radio button file export choice.

Further in connection with the example embodiment, FIGS. 3(g)-3(h) depict an example operation of the OCUI icon of the invention. In FIG. 3(g), the user has opened the Target windows 60 and 70 on that users' computer system that show lists of music files. The OCUI Icon 11 has been configured to recognize a window as its Target area. Some of the lists have both music (*.MP3) files and other files. Only the music file Objects will be selected by the OCUI Icon 11 as it is dragged to each window. This is because the user specified a file “mask” that only allows “MP3” files to be seen by the OCUI. The format of the “mask” is O/S dependent. Some operating systems support multiple masks (EG. *.MP3;*.WMF). It is understood that, even though a file has an extension of MP3, this does not guarantee that it is a music file. In other O/S's such as Linux, for example, the file name may be less relevant as a file type identifier. When the OCUI Icon collects Attributes from a selected Object its actual properties and attributes will determine the information that is collected. FIG. 3(h) depicts the use of the OCUI icon 11 that the user has dragged to each window 60, 70. As shown in FIG. 3(h), in response to releasing the icon 11 at each window, an action menu 75 is presented providing a “capture” action menu choice 80 that enables the user to capture the attributes of the specified objects in the target. The Icon 11 is used in a similar way with many different windows which represent different directories and different sets of files.

In order to review the results of the capture action, the user may right click on the OCUI Icon 11 and select a “Properties” menu choice which displays the “Collector Properties” dialog box 40 as shown in FIG. 3(i). From the “Collector Properties” dialog box 40 the user selects the Results tab 37 that indicates the current statistics (counts) 85 for the information of files that have been collected. Note that, in the example embodiment depicted, the save area includes 200 entries and is 17K bytes in size. The user can now browse or clear the results at any time. As shown in the example embodiment, the two check boxes provided 57 are blank indicating that no additional information has been recorded for the collected results. The user can subsequently select the “Export” button 90 at any time to format the save area as a CSV file. The exported file having the saved data will be called “My Music.CSV” as earlier specified via the “Results” dialog box of FIG. 3(f). This saved data can be recalled as a file that will present the saved resource and its attributes for immediate or later use. In the example embodiment described, when the results are exported upon selection of the “Export” button 90 (FIG. 3(i)), the “My Music.CSV” file will have one row for each file that was collected. The rows will have four fields each where the fields will represent the Attributes selected on the Attribute tab 36 of FIG. 3(e). In this example the rows will correspond to the selected attributes 53a-53d in FIG. 3(e)) and represent:
“File Name” “Music Title” “Artist” “Duration”

Thus, an example of what this data would look like is as follows:
“Song1.MP3”, “Sousa March”, “Boston Pops”,“3.00”
“Song2.MP3”, “Aria”, “Caruso”, “4.50”
“Tune1.mp3”, “piano music”,“ ”, “3.30”
“Tune2.MP3”, “tuba music”, “Hoboken Tuba Band”, “8.33”

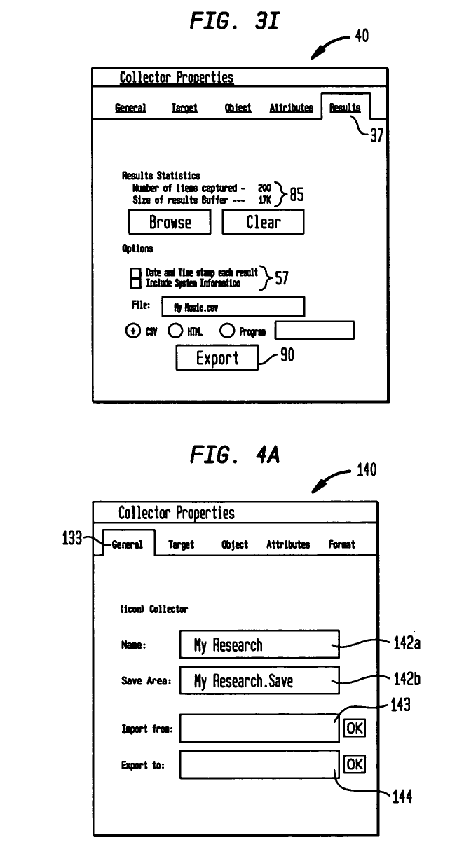

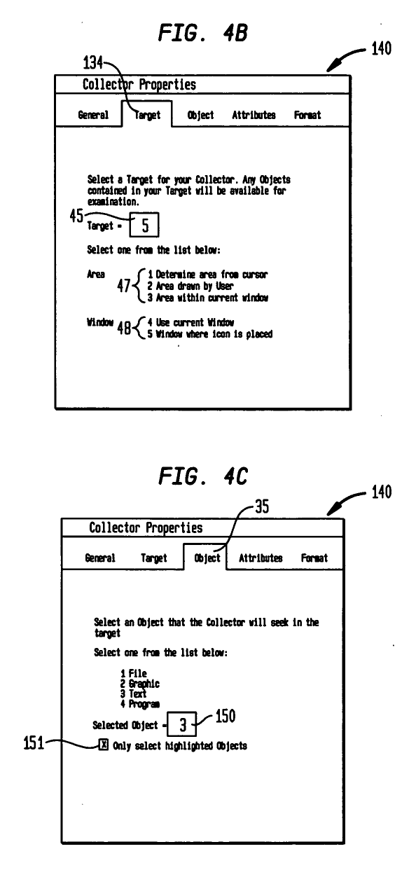

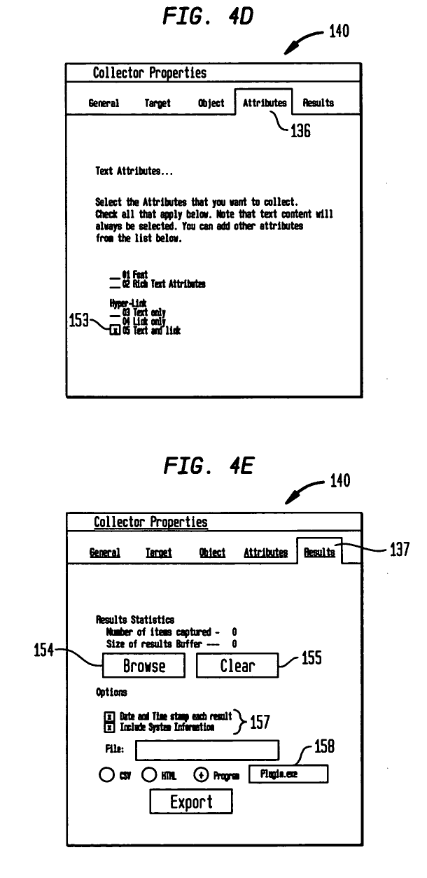

In another example application, the OCUI is programmed to consolidate research results from the Web and other sources. In this example, a user wishes to search for information using various Web based searches and notes from various word processor files. The user wants to make a collection of excerpts of text and links from these sources. Once all the data is collected the user wants to save the data as an HTML page using a third party program that is designed to work with the OCUI. Thus, as described herein with respect to FIG. 3(a), a first step involves creating the OCUI Icon. By right clicking on the user's desktop and selecting “New” and “Collector” menu such as depicted in FIG. 3(a) in connection with the first example application, this will generate for display the Collector Property Dialog box 140, such as shown in FIG. 4(a), for creating a new OCUI icon. Referring to FIG. 4(a) in connection with this second example application, the “Collector Properties” dialog box 140 is displayed in response to creating a new OCUI icon from which the user may configure the properties. Particularly, as shown in FIG. 4(a), the user may select the general tab 133 which enables the user to name the OCUI icon “My Research” in entry field 142a with the save area being named: “My Research.Save” in entry field 142b. In the formatting of this OCUI icon, no import or export information is used as depicted by null fields 143, 144 respectively. FIG. 4(b) depicts the manner in which a user configures the Target property of the example OCUI Icon generated according to this second example application. In response to the user clicking on the “Target” tab 134 from the collector properties interface 140, the user is presented with dialog box enabling user selection and entry of a target for the created Collector icon. In this example, the user has selected the value “5” representing the collection of text and hyper-link information from both a web browser page and a word processor file which appears in windows. FIG. 4(c) depicts the manner in which a user configures the Object property of the example OCUI Icon generated according to this example application. In response to the user clicking on the “Object” tab 135 from the collector properties interface 140, the user is presented with a dialog box enabling user selection of an object for the created Collector icon. The user must identify the Object that the OCUI will examine. In the example application, the user has input an Object value equal to “3” in entry field 150 because that user is looking for text that appears in the target area. As further shown in FIG. 4(c), the user has indicated that only highlighted text will be recognized by the OCUI by selecting entry box 151. In that way the user can specify the extent of the information to be collected from within a large window of text. Further, according to this second example shown in FIG. 4(c), the Attributes tab 136 of the Collector Property Dialog box 140 has automatically recognized that, for this example, the Object tab has been set to “text”. The selection of Attributes is thus dynamically formatted to include only text attributes for display. However, the Attributes dialog interface 136 shown in FIG. 4(c) enables user selection of any or all attributes for the specified object type (e.g., text). According to the preferred embodiment, the actual text is always selected. In addition, according to this example, the user has additionally chosen to collect hyper-link information by selecting attribute 153, for example. The hyper-link will be collected along with the text that highlights the hyper link. It should be understood that the method for saving and rendering hyper-link information is implementation dependent. FIG. 4(e) depicts the manner in which a user configures the Results property of the example OCUI Icon generated according to this example application. In response to the user clicking on the “Results” tab 137 from the collector properties interface 140, the user is presented with a dialog box enabling user selection of Results for the created Collector icon. The Results dialog box particularly shows the current status of the save area and how the results will be managed. Since this is a new Icon there is nothing in the save area as depicted in FIG. 4(e). Subsequently, however, the user can browse or clear the current set of results using the Browse or Clear 154,155 buttons provided. The user has additionally marked the additional date/time stamp and system information 157 that will be collected when new results are added to the save area. The selected output format 158 is “Program” and the collected results will be formatted by the “Plugin.exe” program as shown in FIG. 4(e).

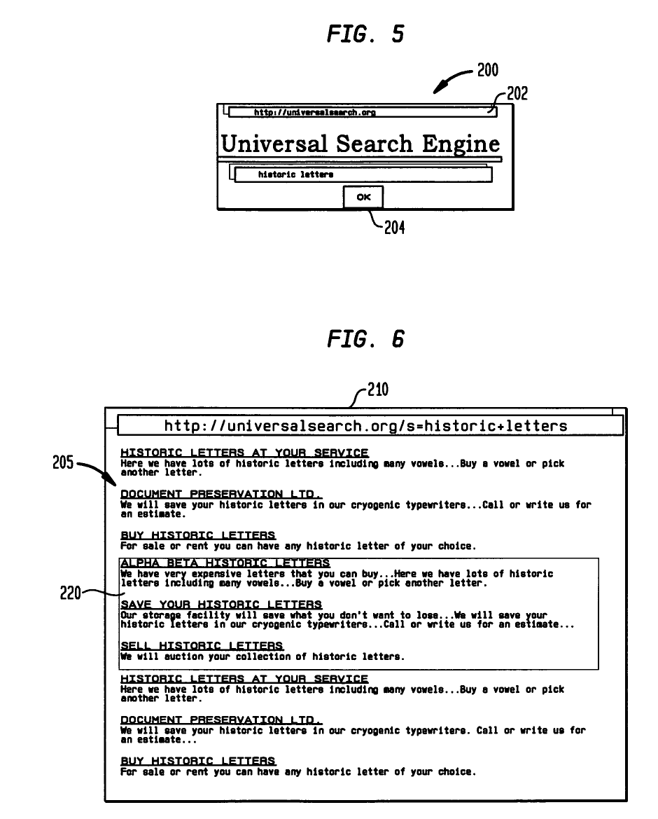

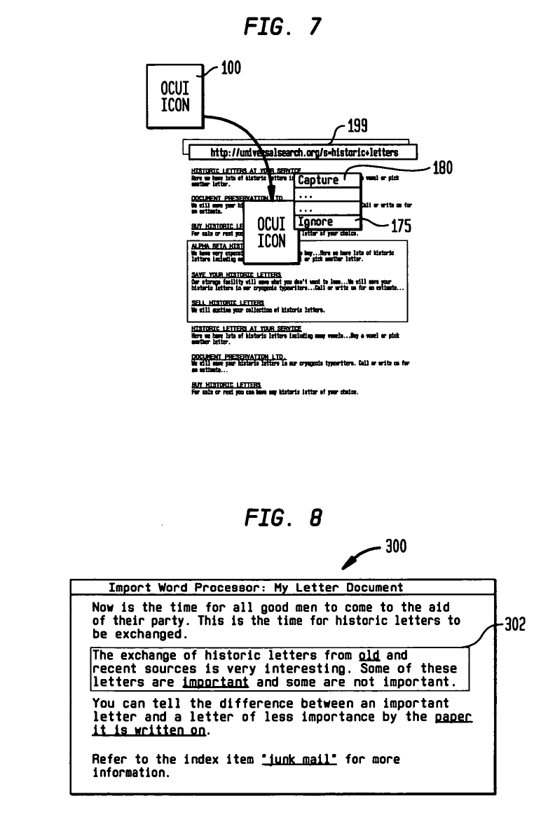

Thus, after the OCUI icon is created, a web browser is used to access a search web site. The user is looking for information about “historic letters”. As shown in FIG. 5, in the URL line 202 of the web browser interface 200, the user may enter the URL of the search web site. The input area is filled in with the appropriate search information and the user presses “OK” button 204 to execute the search. The results 205 of the search are returned to the user in a new window 210 as shown in FIG. 6. Among the results, the user has highlighted a set of three search results 220 that should be collected. Note that the URL for this page is shown at the top of the window. Then as shown in FIG. 7, in the application utilizing the OCUI icon in this second example, the user drags the OCUI Icon 100 to the window 199 and releases it. In response, the action menu 175 is presented providing a “capture” action menu choice 180 that enables the user to capture the attributes of the specified objects in the target. The Icon 100 is used in a similar way with many different windows which represent display text from different sources. As the Icon 100 in this second example was configured to collect text and hyper-links from highlighted areas, the highlighted text and the associated hyper-links will be collected and saved in the Icon's save area.

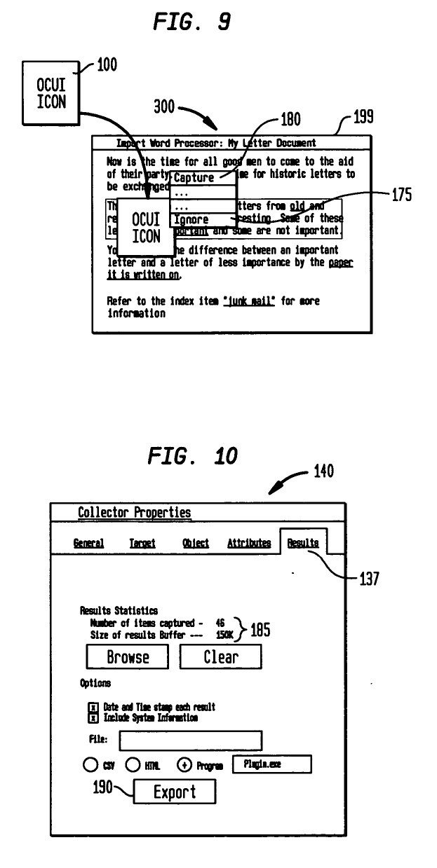

In accordance with the OCUI icon 100 generated in accordance with the second example application, the highlighted text and any included hyperlinks are collected. In addition, the collection date, time, and system information is also captured as specified in FIGS. 4(d) and 4(e). The user may repeat this action with various other web searches. Then, as shown in FIG. 8, the user will examine the word processor documents. That is, the user may subsequently open a document 300 with the word processor and the text of the document appears in the word processor's window. The user then highlights text 302 that should be collected from within the document. Then, as shown in FIG. 9, the user may drag the OCUI Icon 100 to the window 199 and releases it. When the action menu 175 appears, the user selects the “capture” action 180. Since the Icon was configured to collect text and hyper-links from highlighted areas, the highlighted text and the associated hyper-links will be collected and saved in the Icon's save area. The highlighted text and any included hyperlinks are collected. In addition, the collection date, time, and system information is also captured. The user may repeat this action with various other text documents. These documents could be rendered on the screen using any program that can display them in a window.

Once all the web and document searches are completed the user can export the collected information. To export the collected results the user opens the Properties dialog of the OCUI Icon and selects the Results tab 137 that indicates the current statistics (counts) 185 for the text that has been collected. Note that, in the second example embodiment depicted in FIG. 10, the save area included 46 text items occupying 150K of space in the save area. As mentioned herein with respect to FIG. 4(e), the Results tab 137 has been configured to invoke the “Plugin.exe” program to produce the user's output. When the user presses the Export button 190 the “Plugin.exe” program will access the save area and produce output for the user. It is understood that the output of the “Plugin.exe” program is implementation dependent and can include the date and time of each collected entry, the text of the entry and any hyper links. The properties of the OCUI Icon and the properties of the each collected Target are also known to the “Plugin.exe” program. These too may be part of the program's output for the user.

The main advantage of the solution provided by the OCUI icon is that it allows the user to collect data that normally would require programming interfaces to perform the job. Besides that, it allows the user to collect data, such as error messages or information from transient windows, which would otherwise be captured only in screen-shots. All of this data can be collected as research or history and used for other purposes.

For instance, if a new product were being tested and a tester wanted to keep a record of the error messages, that tester could invoke the collector icon and save each message with some associated data (or comments) as each message occurred. This would be done without programming or modification to the application under review. The product could come with a properties file that would be imported into an OCUI Icon to initialize all of the needed settings.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

Having thus described my invention, what I claim as new, and desire to secure by Letters Patent is:

1. A data collection tool for a computer device having a display interface comprising:
a graphic element adapted for manipulation by a user on said display interface having programmable properties for collecting hidden information associated with a target element present on said display interface;
a memory storage device for storing collected hidden data contents according to a user-specified manner.

2. The data collection tool of claim 1, wherein the graphic element operates in conjunction with one or more application programming interfaces (APIs) provided for a computing platform in which said computer device operates to expose types of data to be collected, said data types including attributes of said target element.

3. The data collection tool of claim 2, wherein the graphic element operates in conjunction with an API to obtain hidden information including one or more of: the name of the target element, the program that is associated with the target element, the logical size or dimensions of the element, any pointers to the content of the target element; or, parameters regarding the status of the target element.

4. The data collection tool of claim 1, further comprising means for generating a user interface adapted to enable a user to specify said programmable properties for said graphic element, said properties comprising one or more of: a target area in which said graphic element operates; an object type that the graphic element will seek in the target area; and, one or more attributes of said object type in the target.

5. The data collection tool of claim 4, wherein said specified target area comprises one or more of: a predetermined area on said display interface, or a Window defined or currently present on said display interface.

6. The data collection tool of claim 4, wherein said specified object types comprise one or more of: a file, a graphic element, text, a program, or a representation of these object types.

7. The data collection tool of claim 6, wherein specified file object attributes comprise one or more of: an object name; object size or dimension; object type; date object was modified; date object was created; date object was accessed; object status; object owner; an object's encrypted or security status; an object's compression status; and, object title or other properties of the object.

8. The data collection tool of claim 6, wherein specified text object attributes comprise one or more of: a font type; rich text attributes; and a hyperlink.

9. The data collection tool of claim 4, wherein said specified programmable properties further includes a results property for indicating said user-specified manner for storing and organizing said collected data.

10. The data collection tool of claim 4, wherein said results property enables specification of a name and environment in which said collected data are to be stored and retrieved.

11. The data collection tool of claim 10, wherein said environment in which said collected data for said graphic element are to be stored include a CSV (comma separated values) file format, an HTML, or a program.

12. The data collection tool of claim 4, wherein said graphic element comprises means adapted for collecting data only from pre-selected highlighted target elements present in said target area.

13. The data collection tool of claim 2, wherein a computing platform in which said graphic element operates comprises one or more of: Windows® operating system; the UNIX operating system AIX and LINUX.

14. The data collection tool of claim 9, wherein said graphic element is adapted to build a list of information of values according to a pre-specified format that are stored in various directories in a system platform.

15. The data collection tool of claim 9, wherein said graphic element is adapted to consolidate research results conducted from a Word Wide Web search, text file displays, e-mail messages and other word processor sources, said collected data adapted to be stored and organized as a collection of text excerpts and links from these sources.

16. The data collection tool of claim 1, wherein said graphic element includes programmable properties for collecting visible information associated with a target element.

17. A method for collecting data from target elements displayed on a display interface of a computer device comprising:
manipulating a graphic element on said display interface to a target area having one or more displayed target elements, said graphic element having programmable properties for collecting hidden information associated with a target element; and,
storing collected hidden data contents according to a user-specified manner.

18. The method for collecting data according to claim 17, wherein the graphic element operates in conjunction with one or more application programming interfaces (APIs) provided for a computing platform in which said computer device operates to expose types of data to be collected, said data types including attributes of said target element.

19. The method for collecting data according to claim 18, wherein the graphic element operates in conjunction with an API to obtain information including one or more of: the name of the target element, the program that is associated with the target element, the logical size or dimensions of the element, any pointers to the content of the target element; or, parameters regarding the status of the target element.

20. The method for collecting data according to claim 17, further comprising the step of: generating a user interface adapted to enable a user to specify said programmable properties for said graphic element, said properties comprising one or more of: a target area in which said graphic element operates; an object type that the graphic element will seek in the target area; and, one or more attributes of said object type in the target area.

21. The method for collecting data according to claim 20, wherein said step of specifying a target area comprises specifying one or more of: a predetermined area on said display interface or, a Window defined or currently present on said display interface.

22. The method for collecting data according to claim 20, wherein said step of specifying object types includes specifying one or more of: a file, a graphic element, text, a program, or the representations of these object types.

23. The method for collecting data according to claim 20, wherein said step of specifying object attributes comprises specifying one or more of: an object name; object size or dimension; object type; date object was modified; date object was created; date object was accessed; object status; object owner; an object's encrypted or security status; an object's compression status; and, object title or other properties of the object.

24. The method for collecting data according to claim 20, further comprising the step of specifying a results property for indicating said user-specified manner for storing and organizing said collected data.

25. The method for collecting data according to claim 24, wherein said step of specifying a results property includes specifying a name and environment in which said collected data are to be stored.

26. The method for collecting data according to claim 25, wherein said environment in which said collected data for said graphic element are to be stored include a CSV (comma separated values) file format, an HTML, or a program.

27. The method for collecting data according to claim 20, further comprising the step of highlighting pre-selected target elements present in a target area, said graphic element collecting data only from said highlighted pre-selected target elements present in said target area.

28. The method of claim 17, wherein said graphic element includes programmable properties for collecting visible information associated with a target element.

29. A program storage device readable by a machine, tangibly embodying a program of instructions executable by the machine to perform method steps for collecting data from target elements displayed on a display interface of a computer device, said method steps including the steps of:
manipulating a graphic element on said display interface to a target area having one or more displayed target elements, said graphic element having programmable properties for collecting hidden information associated with a target element; and,
storing collected hidden data contents according to a user-specified manner.

30. The program storage device readable by a machine as claimed in claim 29, wherein the graphic element operates in conjunction with one or more application programming interfaces (APIs) provided for a computing platform in which said computer device operates to expose types of data to be collected, said data types including attributes of said target element.

31. The program storage device readable by a machine as claimed in claim 30, wherein the graphic element operates in conjunction with an API to obtain information including one or more of: the name of the target element, the program that is associated with the target element, the logical size or dimensions of the element, any pointers to the content of the target element; or, parameters regarding the status of the target element.

32. The program storage device readable by a machine as claimed in claim 29, wherein said method steps further comprises the step of: generating a user interface adapted to enable a user to specify said programmable properties for said graphic element, said properties comprising one or more of: a target area in which said graphic element operates; an object type that the graphic element will seek in the target area; and, one or more attributes of said object type in the target area.
